(19) United States
(12) Patent Application Publication
(10) Pub. No.: US 2025/0046839 A1
(43) Pub. Date: Feb. 6, 2025

(54) APPARATUS AND METHOD FOR DETECTING OR CONTROLLING CARBON BUILDUP IN A DIRECT CARBON FUEL CELL

(71) Applicant: EKONA POWER INC., Burnaby (CA)

(72) Inventor: Kenneth William Kratschmar, Vancouver (CA)

(21) Appl. No.: 18/717,950

(22) PCT Filed: Oct. 5, 2022
(86) PCT No.: PCT/CA2022/051472

§ 371 Date: Jun. 7, 2024

Related U.S. Application Data
(60) Provisional application No. 63/292,137, filed on Dec. 21, 2021.

(51) Int. Cl. H01M 8/04537; H01M 4/86; H01M 8/023; H01M 8/04276; H01M 8/04664; H01M 8/04746; H01M 8/14; H01M 8/22

(52) U.S. Cl. CPC H01M 8/04641; H01M 4/8657; H01M 8/023; H01M 8/04276; H01M 8/04671; H01M 8/04753; H01M 8/143; H01M 8/145; H01M 8/225; H01M 2008/147

(57) ABSTRACT

A direct carbon fuel cell (DCFC) has a conductive mesh between an anode and a cathode of the DCFC. The conductive mesh is positioned at a specified distance from the anode. As the DCFC is operated, a carbon/carbonate fluid flows through the conductive mesh and though the porous anode. If the rate of carbon introduced into the DCFC is greater than the amount consumed, carbon will build up on the surface on the anode. Once the carbon build-up reaches the mesh, a conductive path will be created between the mesh and anode. A controller in contact with the conductive mesh measures the resistance between the conductive mesh and the anode and when the measured resistance falls to or below a defined set-point indicating a resistance when a conductive path between the anode and conductive mesh has formed, the controller can send a carbon build-up detected signal, and/or execute mitigation actions to reduce the amount of carbon delivered to the cell.

### FIELD OF THE DISCLOSURE

The present disclosure relates generally to direct carbon fuel cells and specifically to detecting or controlling carbon buildup in a direct carbon fuel cell.

### BACKGROUND OF THE DISCLOSURE

The pursuit of direct carbon conversion to electrical power has been explored for more than a century, with past focus primarily on high carbon fuel stocks such as coal and biomass. Recent interest continues to be motivated by concerns over energy and the environment. Direct carbon fuel cells (DCFCs) are characterized by high efficiencies (theoretically 100%) and low emissions, since the primary output product is pure carbon dioxide (CO₂) which can be sequestered or used as an industrial feedstock in various processes. However, DCFC technology is characterized by numerous technical challenges, and has not yet reached a development stage where it is suitable for widespread commercially adoption.

Direct carbon conversion is a high temperature process that can be achieved with different fuel cell technologies, solid-oxide fuel cells (SOFC) and molten carbonate fuel cells (MCFC) being the most common types of DCFCs.

A typical molten carbonate direct carbon fuel cell (MC-DCFC) 100, is illustrated schematically in FIG. 1 (PRIOR ART). As shown in FIG. 1, carbon dioxide (produced at the anode) is mixed with air at the cathode and undergoes a carbonate formation reaction-see equation (1) below. Carbonate ions formed at the cathode are conducted through a molten carbonate (MC) electrolyte where, under the right conditions at a triple phase boundary at the anode, they oxidize solid carbon fuel to produce carbon dioxide-see equation (2) below. In this case, a triple phase boundary (TPB) is a location where carbon fuel is in contact with both the ionically conductive molten carbonate electrolyte and a current carrying electrode which can conduct electrons away to the cathode via a load to complete the electrochemical reaction and produce electrical power. A portion of the product carbon dioxide produced in the carbon oxidation reaction can be separated and directed to the cathode to replenish the consumed carbonate ions and continue the reaction. The net reaction is shown in equation (3) below. On a stoichiometric basis, the cathode will consume ⅔ of the carbon dioxide produced at the anode.

Cathode: O₂+2CO₂+4e⁻→CO₃²⁻ (1)

Anode: C(s)+2CO₃²⁻→3CO₂+4e⁻ (2)

Net reaction: C(s)+O₂→CO₂ (3)

During the reaction, carbon is introduced and flows through a porous anode. Depending on the particle size distribution of the carbon and pore size of the anode, some carbon particles will flow through the anode and some will become lodged into the pores. These lodged particles will begin to react to form CO₂ and electrons. As the reaction continues, the particles get consumed and are replaced by new carbon particles fed to the cell.

When the amount of carbon fed to the DCFC is greater than the amount consumed, carbon particles will begin to build up on the anode surface. In some DCFC cell designs, the carbon fuel is mixed with the carbonate electrolyte and this mixture flows into the gap between the anode and cathode. Some of the carbon/electrolyte mixture flows past the anode and is recirculated but some flows through the porous anode structure. Therefore, a build-up of carbon on the anode could provide a conductive bridge between the anode and the cathode and lead to a short circuit of the cell.

The amount of carbon consumed by the DCFC can be inferred from the voltage and current produced. However, this is a gross, macro measurement and does not address the localized problem address above. A direct means to detect carbon buildup on the anode surface is required which will allow the system to control the amount of carbon fed into the cell and prevent short circuiting and/or to allow for potential mitigation strategies to be implemented to prevent localized buildup.

### SUMMARY

According to a first aspect of the disclosure, there is provided a direct carbon fuel cell system (DCFC) comprising: a fuel cell comprising a porous anode, a porous cathode and an electrolyte flow field chamber in between the anode and the cathode and containing a molten carbonate electrolyte; a conductive mesh in the electrolyte flow field chamber and spaced from the anode; a fuel supply apparatus for flowing a fuel slurry comprising carbon particles and a carbon carrier fluid into the electrolyte flow field chamber, wherein the carbon carrier fluid has a same composition as the molten carbonate electrolyte; an oxidant supply apparatus for flowing an oxidant stream to the cathode; an electrolyte circulation apparatus for circulating the molten carbonate electrolyte to the electrolyte flow field chamber; and a controller in electrical contact with and operable to measure the resistance between the anode and the conductive mesh and compare the measured resistance against a set-point indicating carbon particle build-up on the anode is contacting the conductive mesh and forming a conductive pathway. The molten carbonate electrolyte can comprise one or a combination of Li, Na and K molten salt.

The controller can be operable to send a carbon-build-up detected signal when the measured resistance is at or below the set-point. Alternatively, the controller can further comprise a processor and a memory having encoded thereon instructions executable by the processor to: measure the resistance between the anode and the conductive mesh; when the measured resistance is greater than the set-point; control the fuel supply apparatus to increase a feed rate of carbon particles to the fuel slurry; and when the measured resistance is at or less than the set-point, control the fuel supply apparatus to reduce the feed rate of carbon particles to the fuel slurry.

The DCFC can further comprise a cathode protection barrier positioned between the cathode and fuel slurry in the electrolyte flow field chamber and configured to impede or prevent the carbon particles from electrically contacting the cathode. The cathode protection barrier can be a micro surface coating on the cathode or a porous felt. The conductive mesh can be mounted on the cathode protection barrier and facing the anode

According to another aspect, there is provided a method for detecting carbon build-up in a direct carbon fuel cell comprising a porous anode, a porous cathode, an electrolyte flow field chamber in between the anode and the cathode and containing a molten carbonate electrolyte, and a conductive mesh in the electrolyte flow field chamber and spaced from the anode. The method comprises: measuring a resistance between the anode and the conductive mesh; comparing the measured resistance to a set-point indicating a carbon build-up on the anode is contacting the conductive mesh and forming a conductive pathway; and sending a carbon build-up detected signal when the measured resistance is at or below the set-point.

According to another aspect, there is provided a method for controlling carbon build-up in a direct carbon fuel cell comprising a porous anode, a porous cathode, an electrolyte flow field chamber in between the anode and the cathode and containing a molten carbonate electrolyte, and a conductive mesh in the electrolyte flow field chamber and spaced from the anode, the method comprising: measuring a resistance between the anode and the conductive mesh; when the measured resistance is greater than a set-point indicating a carbon build-up on the anode is contacting the conductive mesh and forming a conductive pathway, increasing a feed rate of carbon particles to a fuel slurry supplied to the electrolyte flow field chamber; and when the measured resistance is at or less than the set-point, reducing the feed rate of carbon particles to the fuel slurry supplied to the electrolyte flow field chamber

Further aspects and example embodiments are illustrated in the accompanying drawings and/or described in the following description.

### BRIEF DESCRIPTION OF THE DRAWINGS

The accompanying drawings illustrate non-limiting example embodiments of the disclosure. The drawings are not intended to be to scale, and in most cases are schematic or simplified intended to clearly illustrate various aspects of the disclosure.

FIG. 1 (PRIOR ART) is a schematic illustration of a conventional molten carbonate direct carbon fuel cell (MC-DCFC).

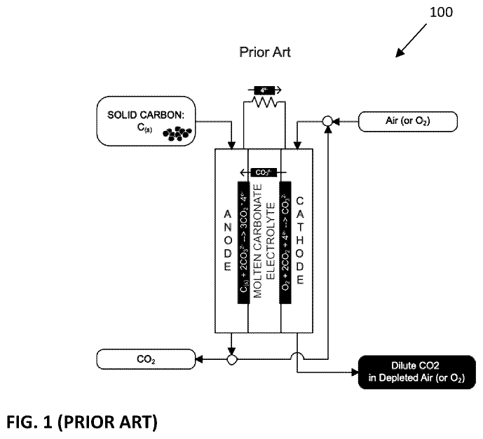

FIGS. 2A and 2B are schematic illustrations of a first embodiment of a molten carbonate DCFC system with a partial flow-through, partial flow-by anode configuration with a single-pump molten carbon electrolyte and carbon fuel slurry circulation loop and with a conductive mesh for detecting carbon buildup, wherein FIGS. 2A and 2B show different amounts of carbon buildup on an anode.

FIGS. 3A and 3B are schematic illustrations of a second embodiment of a molten carbonate direct carbon fuel cell system with a partial flow-through, partial flow-by anode configuration with a dual-pump molten carbon electrolyte circulation and carbon fuel slurry circulation loop, and with a conductive mesh for detecting carbon buildup, wherein FIGS. 3A and 3B show different amounts of carbon buildup on an anode.

FIG. 4 is a schematic illustration of an embodiment of a DCFC with a with a conductive mesh for detecting carbon buildup and a cathode protection barrier.

FIG. 5 is a flow chart of operations performed by a controller to control carbon build-up in a DCFC.

### DETAILED DESCRIPTION OF ILLUSTRATIVE EMBODIMENTS

Throughout the following description, specific details are set forth in order to provide a more thorough understanding of the disclosure. However, the disclosure may be practiced without these particulars. In other instances, well known aspects or features have not been shown or described in detail to avoid unnecessarily obscuring the disclosure. Accordingly, the specification and drawings are to be regarded in an illustrative, rather than a restrictive sense.

Embodiments described herein relate to a DCFC having a conductive mesh in an electrolyte flow field chamber between an anode electrode and a cathode electrode of the DCFC. The conductive mesh is positioned and secured at a specified gap distance from the anode surface. As the DCFC is operated, carbon/carbonate fluid is introduced into the DCFC, a portion flows through the conductive mesh and though the porous anode. If the rate of carbon introduced into the DCFC is greater than the amount consumed, carbon will begin to build up on the surface on the anode electrode. Once the thickness of the carbon buildup equals the gap distance between the mesh and the anode surface, a conductive path will be created between the mesh, carbon particles and anode electrode. A controller in contact with the conductive mesh continuously or periodically measures the resistance between the conductive mesh and the anode electrode and when the measured resistance falls to or below a defined set-point indicating a resistance when a conductive path between the anode and conductive mesh has formed, the controller can send a carbon build-up detected signal, and/or execute mitigation actions to reduce the amount of carbon delivered to the cell.

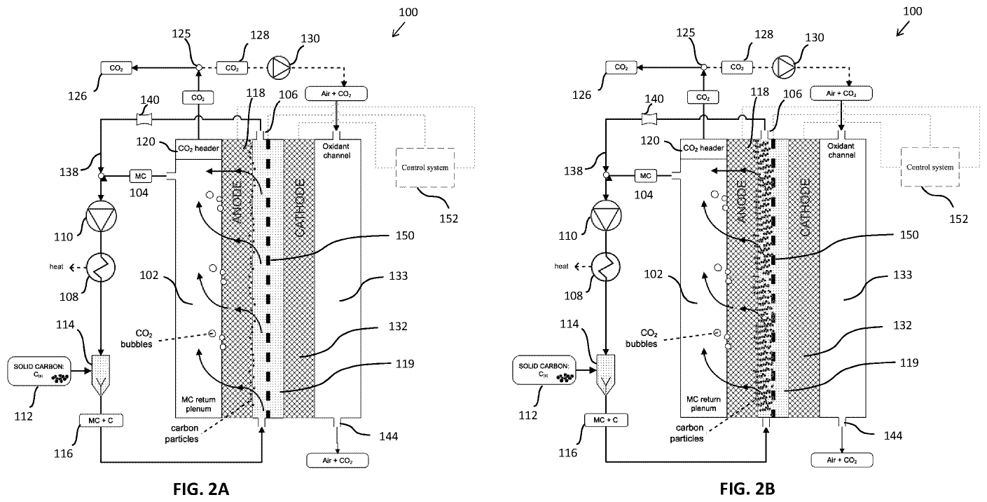

Referring to FIGS. 2A and 2B and according to a first embodiment, a MC-DCFC system 100 is provided having a hybrid flow-through/flow-by anode configuration, wherein not all of the electrolyte from a carbon/electrolyte slurry is circulated through the thickness of porous anode. System 100 is illustrated for a single cell, but it is understood that it could be a system comprising multiple DCFCs electrically connected in series and fed with the various process streams in parallel. In system 100, solid carbon particles from a fuel supply 112 are introduced into and combined with molten carbon electrolyte 104 in a mixer 114, and the resulting carbon/electrolyte slurry 116 is circulated to an electrolyte flow field chamber 119 between an anode 118 and a cathode 132 using a circulation pump 110. The molten carbonate electrolyte 104 can be a Li, Na or K molten salt, or a combination thereof. In these embodiments, the molten carbon electrolyte 104 also serves as a carbon carrier fluid. The mixer 114 can be a device which incorporates and entrains the carbon particles into the molten electrolyte (melt) and facilitates the wetting of the carbon particles. For example, the mixer 114 can comprise a hopper or tank with active or passive agitation, and/or an integrated carbon separator where carbon is extracted from other process streams, such as from a pyrolyzer exhaust stream.

Slurry 116 passes through the electrolyte flow field chamber 119 in contact with the porous anode 118. Some of the slurry permeates the anode 118, and carbon from the slurry is trapped and consumed at the anode 118. The anode 118 comprises a porous electrode separating the carbon slurry 116 from the electrolyte 104 in an electrolyte return chamber 102. The porosity of the electrode facilitates carbon contact, sufficient to promote electrochemical exchange of electrons at triple phase boundary (TPB) sites where the carbon fuel is in electrical contact with the anode 118, and in ionic contact with the electrolyte 104. The molten carbonate, as the carbon carrier fluid, helps ensure the carbon is wetted, which facilitates contact with carbonate ions in the electrolyte 104. The porous anode 118 permits some of the carbon carrier fluid (MC) to pass into and, in this case, through the anode 118, and serve to effectively trap or filter the carbon fuel from the slurry. The carbon carrier fluid (MC) having passed through the anode 118 rejoins the bulk electrolyte 104 in the electrolyte return chamber 102. Solid carbon particles, which are trapped at the porous anode 118, are consumed in the oxidation reaction forming product CO₂ gas, which accumulates in the headspace 120 in the upper portion of the electrolyte return chamber 102.

Electrolyte 104 that passes through anode 118 enters the electrolyte return chamber 102. The remainder of the electrolyte slurry 116, with a depleted carbon loading, exits flow field chamber 119 at outlet 106 and is combined with electrolyte 104 from the electrolyte return chamber 102 via conduit 138. The combined electrolyte stream can be cooled in a heat exchanger 108, have more carbon added at mixer 114, and be recirculated back to flow field chamber 119.

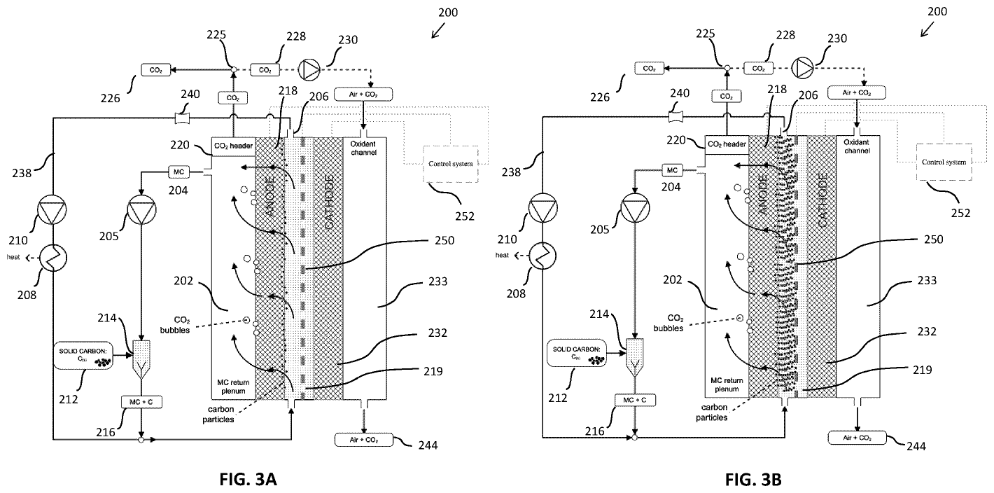

The ratio of flow of electrolyte (slurry) through outlet 106 versus through anode 118 and into electrolyte return chamber 102 can be controlled to some degree by the anode porosity. A flow restriction 140 can also be positioned in the main electrolyte loop, for example, to ensure that there is sufficient pressure drop across the anode to force carbon particles to TPB sites and to flush product CO₂ into the (substantially) carbon-free electrolyte slipstream in return chamber 102. Flow restriction 140 may be a passive orifice restriction, an active back-pressure regulator or similar or other suitable device. In other embodiments, the ratio of flow of electrolyte (slurry) through outlet 106 versus through anode 118 and into electrolyte return chamber 102 can be further controlled by having two independent pumps and flow paths, such as shown in FIGS. 3A and 3B.

To some extent, the configuration of system 100 enables decoupling of two electrolyte flow stream functions: (1) the “slipstream” delivery of carbon particles to the anode with (2) the entrainment of product CO₂ gas away from the carbon bed and the bulk flow of electrolyte as a heat exchange medium. In the illustrated embodiment, the electrolyte 104 from return chamber 102 and the bulk electrolyte (depleted slurry) flow from flow field chamber 119 are re-combined upstream of heat exchanger 108. It can be appreciated that these streams can be combined downstream of the heat exchanger, kept independent or otherwise configured to accomplish the desired goals for each stream.

The product CO₂ gas accumulated in the headspace 120 in the electrolyte return chamber 102 is discharged from the fuel cell. A portion of the CO₂ can then be circulated to the cathode 132 for the cathode carbonate formation reaction. In system 100, product CO₂ gas is split into two streams at 125, with one DCFC exhaust stream 126, and one recirculation stream 128 which is circulated via a recirculation compressor 130 to a cathode flow field chamber 133, together with an oxidant stream (such as air or pure oxygen). Unreacted CO₂ gas can be discharged from the cathode flow field chamber 133 at exhaust port 144.

A conductive mesh 150 extends along the length of the electrolyte flow field chamber 119 generally parallel to and spaced from the anode 118. The gap spacing between the conductive mesh 150 and anode surface 118 can be selected depending on the amount of carbon build-up on the anode 118 is tolerable before mitigation action is taken. The mesh material can be made from materials known in the art that are compatible for use with molten carbonates in terms of temperature and corrosion resistance and be of a pore size which allows the carbon entrained in the slurry 116 to freely pass through.

A controller 152 is in electrical contact with the conductive mesh 150, anode 118 and cathode 132, and is operable to measure the resistance between the anode 118 and the conductive mesh 150 to detect carbon build up in the fuel cell, and in some embodiments to control or mitigate against carbon build in the fuel cell. In a basic embodiment, the controller 152 operates as a monitor and sends a carbon build-up detected signal when a measured resistance falls to or below a set-point value, indicating that carbon build up has reached the anode 118 to form a conductive pathway. In another embodiment the controller 152 comprises a processor and a memory having encoded thereon program code executable by the processor to perform a carbon build-up mitigation operation when the measured resistance falls to or below the set-point value.

Referring now to FIGS. 3A and 3B and according to another embodiment of a MC-DCFC system 200, the flow ratio between a through-anode electrolyte flow and a bulk electrolyte cooling medium flow is controlled using independent pumps controlling the flows in each path. The MC-DCFC system 200 is similar to the system 100 illustrated in FIGS. 2A and 2B, and again has a hybrid flow-through/flow-by anode configuration. System 200 is illustrated for a single cell, but again it is understood that it could be a system comprising multiple DCFCs electrically connected in series and fed with the various process streams in parallel. In system 200, solid carbon particles from a fuel supply 212 are introduced into and combined with molten carbon electrolyte in a mixer 214, and the resulting carbon/electrolyte slurry 216 is circulated to a flow field chamber 219 between the anode 218 and cathode 232 by a first circulation pump 205. Again some of the slurry permeates the anode 218, and carbon from the slurry is trapped and consumed at the anode 218. Electrolyte that passes through anode 218 enters electrolyte return chamber 202, has more carbon added at mixer 214, and is recirculated back to flow field chamber 219 by first circulation pump 205. The remainder of the electrolyte slurry, with a depleted carbon loading, exits flow field chamber 219 at outlet 1306 and is circulated through heat exchanger 208 by a second circulation pump 210. It is then combined with slurry from mixer 214 and recirculated back to flow field chamber 219.

First recirculation pump 205 can be used to appropriately regulate the flow and pressure drop across the anode to ensure appropriate carbon accumulation and CO₂ product gas management. The flow rate of second recirculation pump 210 can be set to provide the desired heat extraction in heat exchanger 208, for example, to maintain a preferred stack temperature and/or temperature rise across the fuel cell or stack(s). This type of configuration can be used to introduce an additional degree of control freedom at the cost of additional balance of plant equipment. An optional flow restriction 240 can also be positioned in the main electrolyte loop to provide further control of flow of electrolyte (slurry) through outlet 206 versus through anode 218 and into electrolyte return chamber 202.

Like the first embodiment, a conductive mesh 250 extends along the length of the electrolyte flow field chamber 219 generally parallel to and spaced from the anode 218. The gap spacing between the conductive mesh 250 and anode surface 218 can be selected depending on the amount of carbon build-up on the anode 218 is tolerable before mitigation action is taken.

Like the first embodiment, a controller 252 is in electrical contact with the conductive mesh 250, anode 218 and cathode 232, and is operable to measure the resistance between the anode 218 and the conductive mesh 250 to detect carbon build-up in the fuel cell, and in some embodiments to control or mitigate against carbon build-up in the fuel cell. In a basic embodiment, the controller 252 operates as a monitor and sends a carbon build-up detected signal when a measured resistance falls to or below a set-point value, indicating that carbon build-up has reached the anode 118 to form a conductive pathway. In another embodiment the controller 252 comprises a processor and a memory having encoded thereon program code executable by the processor to perform a carbon build-up mitigation operation when the measured resistance falls to or below the set-point value.

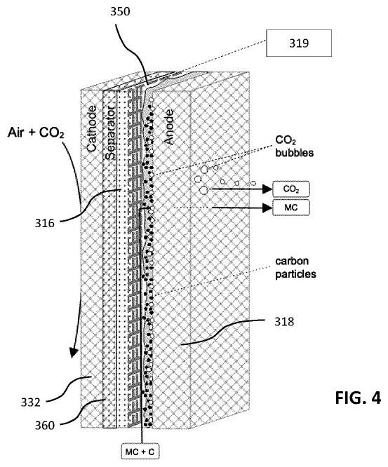

A cathode protection barrier (not shown) can be used in any of the various MC-DCFC systems 100, 200 described herein, which have carbon slurry between the anode and cathode, to mitigate potential oxidation of carbon particles at the cathode, which could otherwise lead to increased heat generation and reduced cell efficiency. FIG. 4 illustrates an example of such a cathode protection barrier 360 positioned between cathode 318 and a molten carbonate slurry 316 flowing in an electrolyte flow field chamber 319 between anode 318 and cathode 332 and through conductive mesh 350. Cathode protection barrier 360 can serve as a local insulator or shield to reduce or prevent solid carbon particles entrained in the carbon/electrolyte slurry from coming into electrical contact with the cathode 332. The protective barrier can be, for example, a micro surface coating or a physical separator such as a porous felt which maintains a certain separation or distance between the carbon in the carbon/electrolyte slurry 316 and the cathode 360. The conductive mesh 350 can be placed in a gap in the electrolyte flow field chamber 319 like the first and second embodiments, or alternatively be mounted to the surface of the cathode protection barrier 360 and facing the anode 318. In this case, the pore size of the conductive mesh 350 can be smaller as carbon particles would not need to pass through.

### Detecting and Controlling Carbon Buildup

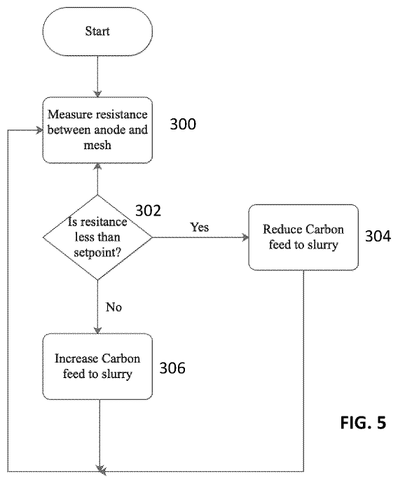

Referring now to FIG. 5 and according to some embodiments, the controller 152, 252 in both the first and second embodiments is programmed to carry out a carbon mitigation operation to control the amount of carbon build-up in the fuel cell. During the carbon mitigation operation, the controller 152 measures the resistance between the anode 118 and the conductive mesh 150 (step 300), and compares the measurement against a set-point (step 302). The set-point is a value representing an electrical resistance of a conductive pathway between the conductive mesh 150 and the anode 118 provided by carbon particles extending between the anode 118 to the mesh 150. In other words, the set-point represents a state where the build-up of carbon particles on the anode 118 has reached the conductive mesh 150. When the resistance is above the set point, there is no conductive pathway yet between the anode 118 and conductive mesh 150, and the controller 152 will continuously increase the carbon feed rate to the slurry, such that the rate of carbon feed exceeds the rate of carbon consumed and carbon build up on the anode 118 will occur. Once the carbon build-up has reached the conductive mesh 150, a conductive pathway is formed and the measured resistance will fall to or below the set-point; the controller 152 then instructs the fuel supply 112 to reduce the carbon feed rate to the slurry (step 304). The controller 152 then returns to step 300 to measure the resistance again, and continuously reduces the carbon feed to the slurry until the rate of carbon feed falls below the rate of carbon consumed, and the carbon build-up is reduced until carbon particles no longer contact the conductive mesh 150. The controller 152 then instructs the fuel supply 112 to increase the carbon feed to the slurry (step 306) then returns to step 300 to measure the resistance again. The controller 152 repeats this operation in a continuous loop, effectively continuously adjusting the carbon feed rate of the fuel supply 112 so that the carbon build-up is always maintained at or just below contact with the conductive mesh.

### Interpretation of Terms

Throughout the disclosure where a controller is referenced it may include one or more controllers in communication with each other through one or more networks or communication mediums. Each controller generally comprises one or more processors and one or more computer readable mediums in communication with each other through one or more networks or communication mediums. The one or more processors may comprise any suitable processing device known in the art, such as, for example, application specific circuits, programmable logic controllers, field programmable gate arrays, microcontrollers, microprocessors, virtual machines, and electronic circuits. The one or more computer readable mediums may comprise any suitable memory devices known in the art, such as, for example, random access memory, flash memory, read only memory, hard disc drives, optical drives and optical drive media, or flash drives. In addition, where a network is referenced it may include one or more suitable networks known in the art, such as, for example, local area networks, wide area networks, intranets, and the Internet. Further, where a communication to a device or a direction of a device is referenced it may be communicated over any suitable electronic communication medium and in any suitable format known to in the art, such as, for example, wired or wireless mediums, compressed or uncompressed formats, encrypted or unencrypted formats.

Unless the context clearly requires otherwise, throughout the description and the
“comprise”, “comprising”, and the like are to be construed in an inclusive sense, as opposed to an exclusive or exhaustive sense; that is to say, in the sense of “including, but not limited to”;
“linked”, “connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.
Words that indicate directions such as “vertical”, “transverse”, “horizontal”, “upward”, “downward”, “forward”, “backward”, “inward”, “outward”, “vertical”, “transverse”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.
Where a component (e.g. a substrate, assembly, device, manifold, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments described herein.

Specific examples of systems, methods, and apparatus have been described herein for purposes of illustration. These are only examples. The technology provided herein can be applied to systems other than the example systems described above. Many alterations, modifications, additions, omissions, and permutations are possible within the practice of this disclosure. This disclosure includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

While particular elements, embodiments and applications of the present disclosure have been shown and described, it will be understood, that the disclosure is not limited thereto since modifications can be made by those skilled in the art without departing from the scope of the present disclosure, particularly in light of the foregoing teachings. It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

1. A direct carbon fuel cell system comprising:
a fuel cell comprising a porous anode, a porous cathode and an electrolyte flow field chamber in between the anode and the cathode and containing a molten carbonate electrolyte;
a conductive mesh in the electrolyte flow field chamber and spaced from the anode;
a fuel supply apparatus for flowing a fuel slurry comprising carbon particles and a carbon carrier fluid into the electrolyte flow field chamber, wherein the carbon carrier fluid has a same composition as the molten carbonate electrolyte;
an oxidant supply apparatus for flowing an oxidant stream to the cathode;
an electrolyte circulation apparatus for circulating the molten carbonate electrolyte to the electrolyte flow field chamber; and
a controller in electrical contact with and operable to measure the resistance between the anode and the conductive mesh and compare the measured resistance against a set-point indicating carbon particle build-up on the anode is contacting the conductive mesh and forming a conductive pathway.

2. The direct carbon fuel cell system as claimed in claim 1, wherein the controller is further operable to send a carbon build-up detected signal when the measured resistance is at or below the set-point.

3. The direct carbon fuel cell system as claimed in claim 1, wherein the controller further comprises a processor and a memory have encoded thereon instructions executable by the processor to:
measure the resistance between the anode and the conductive mesh;
when the measured resistance is greater than the set-point, control the fuel supply apparatus to increase a feed rate of carbon particles to the fuel slurry; and
when the measured resistance is at or less than the set-point, control the fuel supply apparatus to reduce the feed rate of carbon particles to the fuel slurry.

4. The direct carbon fuel cell as claimed in claim 1, further comprising a cathode protection barrier positioned between the cathode and fuel slurry in the electrolyte flow field chamber and configured to impede or prevent the carbon particles from electrically contacting the cathode.

5. The direct carbon fuel cell as claimed in claim 4, wherein the cathode protection barrier is a micro surface coating on the cathode, or a porous felt.

6. The direct carbon fuel cell as claimed in claim 5, wherein the conductive mesh is mounted on the cathode protection barrier and facing the anode.

7. The direct carbon fuel cell as claimed in claim 1, wherein the molten carbonate electrolyte comprises one or a combination of Li, Na and K molten salt.

8. A method for detecting carbon build-up in a direct carbon fuel cell comprising a porous anode, a porous cathode, an electrolyte flow field chamber in between the anode and the cathode and containing a molten carbonate electrolyte, and a conductive mesh in the electrolyte flow field chamber and spaced from the anode, the method comprising:
measuring a resistance between the anode and the conductive mesh;
comparing the measured resistance to a set-point indicating a carbon build-up on the anode is contacting the conductive mesh and forming a conductive pathway; and
sending a carbon build-up detected signal when the measured resistance is at or below the set-point.

9. A method for controlling carbon build-up in a direct carbon fuel cell comprising a porous anode, a porous cathode, an electrolyte flow field chamber in between the anode and the cathode and containing a molten carbonate electrolyte, and a conductive mesh in the electrolyte flow field chamber and spaced from the anode, the method comprising:
measuring a resistance between the anode and the conductive mesh;
when the measured resistance is greater than a set-point indicating a carbon build-up on the anode is contacting the conductive mesh and forming a conductive pathway, increasing a feed rate of carbon particles to a fuel slurry supplied to the electrolyte flow field chamber; and
when the measured resistance is at or less than the set-point, reducing the feed rate of carbon particles to the fuel slurry supplied to the electrolyte flow field chamber.

10. The method of claim 8, wherein the molten carbonate electrolyte comprises one or a combination of Li, Na and K molten salt.

11. The method of claim 9, further comprising sending a carbon build-up detected signal when the measured resistance is at or below the set-point.

12. The method of claim 9, wherein the direct carbon fuel cell further comprises a cathode protection barrier positioned between the cathode and fuel slurry in the electrolyte flow field chamber and configured to impede or prevent the carbon particles from electrically contacting the cathode.

13. The method of claim 12, wherein the cathode protection barrier is a micro surface coating on the cathode, or a porous felt.

14. The method of claim 13, wherein the conductive mesh is mounted on the cathode protection barrier and facing the anode.

15. The method of claim 9, wherein the molten carbonate electrolyte comprises one or a combination of Li, Na and K molten salt.
